(19) United States
(12) Patent Application Publication
(10) Pub. No.: US 2005/0270432 A1
(43) Pub. Date: Dec. 8, 2005

(54) Digital LCD Windshield Display Unit

(75) Inventor: Eugene Overline, Gilbert, AZ (US)

Correspondence Address: Eugene Overline;Plasma Industries, Suite 4, 130 N Sunway Drive, Gilbert, AZ, 85233, US

(73) Assignee: PLASMA INDUSTRIES, Gilbert, AZ (US)

(21) Appl. No.: 10/709,932

(22) Filed: Jun. 7, 2004

(51) Int. Cl. G02F 1/1335

(52) U.S. Cl. 349/16

(57) ABSTRACT

Automotive instrument clusters provide valuable information about a vehicle, but distract the driver's attention from the road. Automotive head-up display systems seek to solve this problem, but require costly and complex modifications to a vehicle. Using a backlit transmissive LCD panel, this same information can be displayed in reverse on a dash mounted device that is viewed as a reflection in the windshield of a vehicle. Displayed inside the driver's field of vision, the display will eliminate the need to take one's eyes from the road in order to assess vehicle data normally displayed elsewhere. The display consists of a transmissive LCD panel (pixel or character based, depending upon application), 1 or more LED lights or electro luminescent backing for backlighting and a case to prevent light from escaping in any direction other than that of the windshield.

### BACKGROUND OF INVENTION

This invention is relevant to the field of all automotive informative gauges/displays as well as the more recent field of automotive Head-Up Displays.

Liquid Crystal Displays (LCDs) have become a widespread, inexpensive, low power method of displaying alpha-numeric or pixel-based information. They can be found on virtually any electronic device ranging from watches to computers to automobiles. Their versatility lies in their ability to take a pre-defined area on it's surface and instantly change it's state from transparent to opaque, giving them high visibility and a fast refresh rate.

Liquid crystal molecules are opaque, but are easily and uniformly manipulated, under the correct conditions. In an LCD panel, a conductive plate is set under a layer of these molecules and controls them with it's electrical field. In the OFF position, the liquid crystal display is transparent, which by it's manufacture is the default state. However, when voltage is applied to the conductive plates embedded in the LCD panel, the liquid crystal molecules are forced to rotate to comply with the electrical field thus generated. This rotation changes the polarization of either transmitted or reflected light through the LCD, or in simpler terms; it becomes opaque. When the electrical field relents, the liquid crystal molecules return to their default physical state, leaving light to pass through uninhibited, as long as the observer is in the ideal viewing range. The reason for this is that the LCD screen is polarized in all parts, at all times. However, within the defined viewing range, the LCD is transparent in the absence of electrical fields, and opaque in their presence. These electrical fields, because of their close proximity to the pixels (transmissive/opaque areas) are relatively weak, and require small voltages to function, making LCD's an efficient solution for informative displays.

Heads-Up-Display (HUD) was originally developed for the use of the military in fighter aircraft. Now HUD has been translated to broader commercial use in automotive vehicles. A HUD works by reflecting an image off the windshield into the driver's line of sight. The image presented to the driver is information pertaining to the vehicle's status. For example: speed. This allows the driver to easily determine the vehicle speed while looking out through the windshield. This allows the driver to maintain their heads up position while driving instead of breaking their view of the road in order to determine speed. An intensely lit display is necessary so that it is able to reflect off the windshield and overcome the ambient light of the environment. The equipment necessary to generate the image of a traditional HUD is set below the windshield and the image generated is projected up into the windshield which in turn is reflected off the windshield and into the drivers line of vision. Sometimes special optics are used to define and focus the image so that after the image is reflected off the windshield the driver is presented with a clear and coherent image.

### SUMMARY OF INVENTION

In the case of the Digital LCD Windshield Display Unit, the intent is to attempt to overcome the ambient light of an automobile cockpit in order to utilize the reflective properties of glass in order to produce an image in the field of vision of the driver that relays important information about the vehicle he/she is operating. It is a non-passive display in that it will overcome the ambient light of its environment using any of various backlighting techniques, including but not limited to LED's set behind it in a hood of some kind to prevent light leakage, EL lighting or incandescent or neon bulbs.

The Digital LCD Windshield Display Unit includes the following elements: a plastic case, a backlighting element, a transmissive or reflective LCD panel, an element to interface with the vehicle and provide power for the LCD, a plate to mount assembly to dashboard. An enclosure for the unit is required to protect the delicate LCD panel. The design can accommodate LED's, utilized to prevent the driver's eyes from leaving the road by achieving multiple colored LED's in the unit, one color for normal operation, as well as one or more warning colors, as a color changes are easily identified peripherally, drawing attention to the display better than alphanumeric warnings would. This same design can be applied to neon bulbs or incandescent bulbs with or without colored coatings or a colored sheet for customization. Another lighting alternative is using a sheet or electroluminescent material as part or a reflective LCD panel that would provide backlighting in a smaller package.

Mounted in a window on the light box is a transmissive or reflective LCD panel that controls where light is allowed to pass, using this control to create an alpha-numeric or pixel based display. The light provided internally via LED's, incandescent bulbs, neon bulbs, EL backlighting or any other device that provides visible light will then reflect off of the windshield, forming a display, and will be reflected in reverse form to the driver, eliminating the need to look down at the gauge cluster below the steering wheel.

In order to control the LCD screen and harvest information, part of the manufacture will be a control unit that includes an interface with vehicle data centers as well as internal electronics including circuits fro translation of data to LCD readout, averaging systems and programmable memory to allow the user to “set” specified actions in the interface.

In addition, a plate that includes a swivel-type mount supports the entire assembly and allows it to be aimed to fit each individual driver's specific height for viewing may be included in the design.

In this way the windshield can be used as a display area without any physical modification to the vehicle whatsoever, with results comparable to that of a light-gun assembly HUD.

The purposes of the present invention are as follows: 1. The old style of HUD systems require extreme expertise for installation, calibration and maintenance. This surface mounting Digital Windshield Display Unit would require only simple electronic and automotive knowledge that is within the grasp of most automobile operators today.

2. The Digital Windshield Display Unit requires no modification to a vehicle, as opposed to the old style of HUD systems, which require precious space directly behind the instrument/gauge panel in a vehicle. Such space is at a premium in compact automobiles, and a dashboard mounted system would not disrupt the internal layout or operation of the vehicle's cabin.

3. Existing HUD systems require a heavy draw of power in order to compete with daylight for visibility, bringing interfering EMI fields into the cabin of the vehicle. The Digital Windshield Display Unit requires far less current, with almost no distinguishable interference with the vehicle's existing electronics.

4. A traditional HUD system requires very specialized components which represent a very small market. Because of this, the parts are very expensive due to low demand and specialization of the parts. The Digital Windshield Display Unit uses very inexpensive, widely used components, keeping prices down and making manufacture inexpensive and flexible.

### DETAILED DESCRIPTION

The Digital Windshield Display Unit consists of a dashboard display unit, as well as a vehicle information interface unit placed anywhere in the vehicle.

The Digital Windshield Display Unit's dashboard display unit is constructed of 4 main components, the first being a plastic light box. This light box will have dimensions based upon the width and length of the applied LCD panel, in that it's length and width may be as large as application demands, but no smaller than the width and length of the LCD panel due to the fact that the LCD panel must be contained completely within the light box in order to block all light from exit, except that which the LCD transmits. The depth of the light box will vary according to the size of the LCD panel, in that a larger panel will require more LED's in order to provide uniform illumination for the display, which may require more distance between the LCD and the LED's themselves to achieve said uniformity, while an electro-luminescent layer within the LCD may also be utilized.

The Digital Windshield Display Unit's dashboard display unit's construction also includes a transmissive LCD panel. This panel utilizes the property of liquid crystal molecules to become opaque or transparent by manufacture when exposed to an electrical field. The display may be as large as the application demands, but must be within the dimensions of the intended projection surface (i.e. windshield) in order to be correctly applied. The transmissive LCD will be lit from within the light box it is mounted in by banks of LED lights also mounted inside the light box, behind the LCD. Human readable data will be generated by limiting the electrical currents supplied to the LCD, thus changing the state of specific regions of the LCD from opaque to transparent in pre-specified shapes (being alphanumeric characters or smaller units used in cooperation, i.e. pixels) forming words, numbers and symbols on demand. Said regions will be lit from inside the light box by LEDs, lighting the transparent regions panel in order to create the contrast between charged and non-charged regions of liquid crystal molecules. All of these characters and symbols will be arranged in such a way to be backwards, as all images viewed as a reflection on a flat surface are reversed left to right, and such will be the case with this display.

The Digital Windshield Display Unit's dashboard display unit's construction also includes a bank of LED's mounted in the light box assembly, behind the LCD. The LED's are of the type which has a low profile in order to contribute to the compact size of the complete unit, and also in order provide a wide viewing angle to achieve a uniform illumination across the LCD panel. The number of LED's in the assembly will vary based on the size of the application. Also included in the design of the dashboard display unit may be an on/off switch and/or dimmer switch for the LED's to adjust the operation of the unit to tailor the individual user. Alternately the display unit can be backlit via electroluminescence, neon bulbs or incandescent bulbs in the same manner as stated above.

The final component of the Digital Windshield Display Unit's dashboard display unit's construction is a dashboard mounting bracket that allows the user to provide a stable mount for the dashboard display unit, as well as a method for aiming the device so that the display is at the driver's viewing height.

In order for the dashboard unit to display the desired vehicle status information, an interface must be made between the vehicle and the display. This interface can be placed anywhere in the vehicle and is hard wired to the dashboard display unit in order to supply power as well as control the LCD panel. The LCD panel may also be battery powered with a wireless link to the LCD to Automobile interface. This unit will have an interface for power, an interface for vehicle information, as well as an interface for the user to define specific options such as alerts and color. The interface may include a fabricated connector or just wires to be hard-weird to vehicle information sensors for RPM, speed, temperature, etc.

The above description shall not be construed as limiting the ways in which this invention may be practiced but shall be inclusive of many other variations that do not depart from the broad interest and intent of the invention.

1. I claim patent over this automotive information display utilizing a transmissive LCD screen, an LED or EL backlighting system and a mounting device designed for an automotive interior in the vicinity of a glass surface.

2. Said display is to utilize a windshield for viewing in that it displays a reverse image of the intended information upon its face and said image is reflected via the reflective qualities of a smooth glass surface.

3. Said display is to utilize an input translator which interfaces with the vehicle to detect the data to be displayed on the LCD (speed, RPM, fuel, etc.) and translating said data into a digital signal to operate the LCD panel display.
